(19) United States
(12) Patent Application Publication
(10) Pub. No.: US 2003/0212768 A1
(43) Pub. Date: Nov. 13, 2003

(54) System and method for centralizing and synchronizing network configuration data

(75) Inventor: Gary E. Sullivan, Trabuco Canyon, CA (US)

Correspondence Address: GATEWAY, INC., ATTENTION: IP LAW GROUP (MAIL STOP SD-21), 14303 GATEWAY PLACE, POWAY, CA, 92064, US

(73) Assignee: Gateway, Inc.

(21) Appl. No.: 10/142,221

(22) Filed: May 9, 2002

(51) Int. Cl. G06F 15/177

(52) U.S. Cl. 709/220

(57) ABSTRACT

A system and method for controlling network configuration data (encryption protocol settings, user profiles, network identification values and the like) for a network. Including, one or more information handling systems and a network access point communicatively coupled utilizing a first set of network configuration data, suitable for providing communication between the one or more information handling systems and the network access point. Further, a second set of network configuration data is applied to the one or more information handling systems and the network access point in a controlled manner so as to enable communication between the one or more information handling systems and the network access point utilizing the second set of network configuration data.

### FIELD OF THE INVENTION

The present invention generally relates to the field of computer networking systems, and particularly to the control and communication of network configuration data such as encryption protocol settings, user profiles and network identification values within a network.

### BACKGROUND OF THE INVENTION

Computers have become a mainstay in the lives of many people. Pervasive use in the fields of industry, business, academics and home computing have driven the computer industry to the point where it seems technological breakthroughs happen daily. Resultingly, human society and productivity has become more dependent on human/computer interaction. Fortunately, these breakthroughs and advances have continually driven down the costs of computing for businesses, industry and individuals all the while increasing productivity and efficiency.

Yet, in the face of all these advances, for most, the decision to implement new computer systems or system upgrades is problematic. Stemming from concerns over system down time, which equates to inoperative business periods and diminished level of returns from individual workers, many businesses and industries choose not to upgrade systems, which have become inefficient and more costly in the face of new advances. The concerns are much greater when consideration is given to installing a new computer network. Intimidated by the perceived complexity of installation, maintenance and use, many people and businesses refuse to take advantage of the significant improvements in productivity and efficiency that networking may offer.

Generally speaking, network systems offer tangible benefits such as reduction in software costs, increased efficiency of computing power and the like. However, many still regard these network systems as unreliable and error prone. With this view the networks of today cost them something much more valuable to them than money they cost them time.

Setting up a computer network, however, may involve a time-consuming series of steps. In determining which network is the right fit, users have to decide on what hardware is needed, what software applications are desired, and the like, which may take a considerable amount of time. Then, once everything is in place and physically connected, in order to communicatively link the network clients with a computer network the user may be required to take the time to individually identify each client to the network access point.

For instance, the user may be asked to remember the network configuration data (encryption protocol settings, user profiles, network identification values, and the like) and to take the time to manually enter network configuration data at each client. The network configuration data on a network access point preferably stays in sync with that of the network client otherwise the clients will be cut off from the network. If the user simply forgets the data or improperly enters the network configuration data on a network client, and the network access point has been set with this network configuration data, then the user of the client is cut off from the network and may be faced with having to reset the access point. If the access point is configured as a router, such as a. residential gateway, the reset may reset everything, including the wide area network settings, so that Internet access is lost. Additionally, the network may interface among differing client adapter setups as well as access points having different configurations, such as using inconsistent methods, protocols and terminology. The user time required to accomplish the setting of network configuration data, whether when initializing the network or changing its form, may be burdensome.

Therefore, it would be desirable to have a system and method for centralizing and synchronizing network configuration data for a network.

### SUMMARY OF THE INVENTION

Accordingly, the present invention is directed to a system and method for providing to a network, the capability for a single user to make a one time entry of network configuration data including encryption protocol settings, user profiles, network identification values and the like, communicate the network configuration data to clients of the network (e.g. information handling systems) and the network access point and direct the clients and the access point to apply, in a synchronous manner, the network configuration data. Further, the communication can be encrypted and can occur in a synchronous manner.

In one embodiment, the present invention provides for entering the network configuration data through the use of a user interface information handling system communicatively coupled with the network and storage of the network configuration data. This entering of data automatically generates an instruction message and combines it with the network configuration data in a single communication unit, which is transmitted to the network clients and the network access point. The instruction message directs the network access point and the network clients to apply, in a synchronous manner, the network configuration data it has received and further, directs the network clients to reboot if necessary to successfully apply the network configuration data.

This synchronous application of network configuration data ensures continued communication within the network among the network clients and the network access point. Further, previous network configuration data may be stored on network clients, network access point and the user interface. A function within the network clients and the network access point automatically retains any previous network configuration data until the new network configuration data has been successfully applied and then deletes the previous network configuration data without any further user intervention.

In a first aspect of the present invention, a network system includes at least two information handling systems and a network access point, which is communicatively coupled with the at least two information handling systems utilizing a first set of network configuration data. The network access point is suitable for providing communication between the at least two information handling systems and the at least two information handling systems and the network access point include a second set of network configuration data. Further, the application of the second set of network configuration data on said at least two information handling systems and said network access point is in a synchronous manner. Thus, enabling communication between the at least two information handling systems and the network access point utilizing the second set of network configuration data.

In a second aspect of the present invention, a method is provided for centralizing and synchronizing a second set of network configuration data for a network with at least two information handling systems and a network access point. The second set of network configuration data is received on the network. Then the second set of network configuration data is communicated throughout the network. The second set of network configuration data is applied throughout the network and he application of the second set of network configuration data occurs in a synchronous manner on the plurality of information handling systems and the network access point that comprise the network.

In a third aspect of the present invention, a system for centralizing and synchronizing wireless network configuration data on a wireless network. The wireless network has at least two wireless information handling systems and a wireless network access point, which is communicatively coupled with the at least two wireless information handling systems utilizing a first set of network configuration data. The network access point is suitable for providing communication between the at least two wireless information handling systems. Further, the application of the second set of wireless network configuration data is in a synchronous manner so as to enable communication between the at least two wireless information handling systems and the wireless network access point utilizing the second set of wireless network configuration data.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description serve to explain the principles of the invention.

### BRIEF DESCRIPTION OF THE DRAWINGS

The present invention may be better understood by those persons of ordinary skill in the art by reference to the following drawings, wherein:

FIG. 1 is a generalized diagrammatic view of a network with a network access point and at least two information handling systems;

FIG. 2 a flow diagram illustrating the synchronous application of the network configuration data by the at least two information handling systems and the network access point;

FIG. 3 is a flow diagram illustrating a method for deleting a first set of network configuration data settings stored on network members (e.g., user interface, network clients and network access point);

FIG. 4 is a block diagram of an information handling system, which is capable of serving as the server of the network, user interface information handling system and a network client; and

FIG. 5 is a generalized diagrammatic view of a network, with a server communicatively coupled with a plurality of clients and the network access point, which is operable to employ the present invention.

### DETAILED DESCRIPTION OF INVENTION

Reference will now be made in detail to the presently preferred embodiments of the invention, examples of which are illustrated in the accompanying drawings.

The present invention embodies providing for a user through a single function at a user interface with the network to have the capability of applying, in a controlled manner, the network configuration data (encryption protocol settings, user profiles, network identification values, and the like) on the network client devices and the network access point.

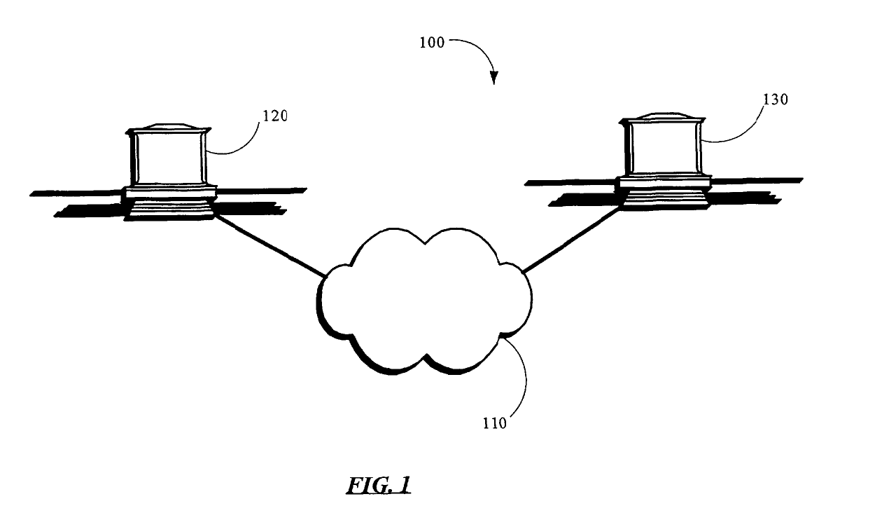

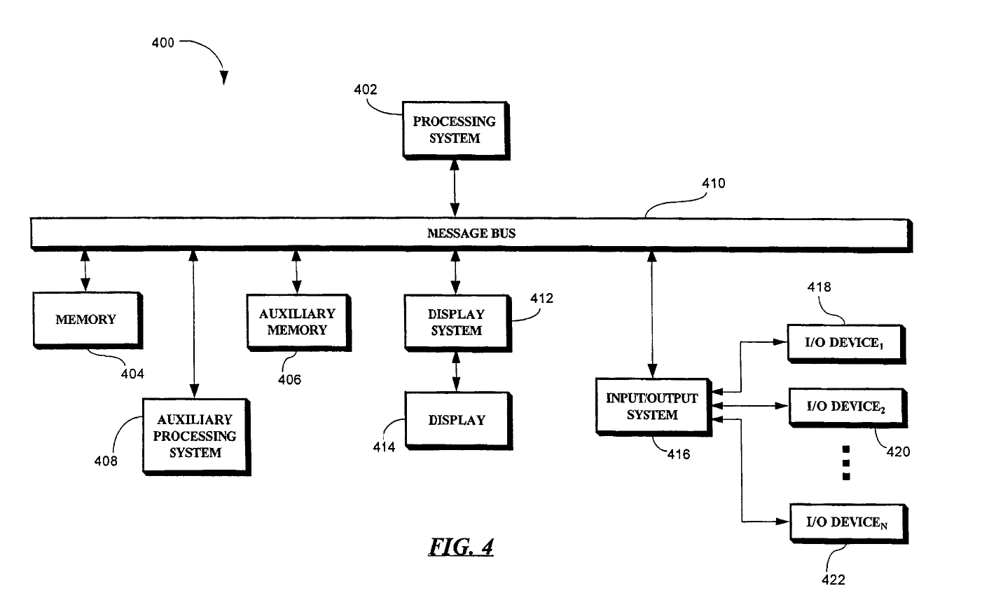

FIG. 1 is a representative diagram of a network 100, which may be set up in accordance with the present invention. In this embodiment, network 100 includes network client 120, network client 130 and the network access point 110. Network access point 110 provides a communicative coupling, allowing the network clients to communicate with the network access point and with each other through the network access point. Further, network access point 110 may include a router, allowing communication with other networks, such as another residential access points and the like. Network clients 120 and 130 are information handling systems (described in FIG. 4) capable of providing a user interface with the network.

The shown representation of network 100 may utilize various channels of communication such as hard wired computer cable, fiber optic and wireless (e.g., infrared, high frequency, blue tooth, 802.11 radio frequency, etc.). Additionally, the network may include a local area network (LAN), wide area network (WAN), Intranet and Internet. It is contemplated that network clients 120 and 130 are information handling systems which may include desktop personal computers, laptop computers, cellular phones, handheld palm pilots, convergence systems, wireless control consoles, computer controlled home appliances and the like. It is considered that network 100 may be composed of one or more network clients.

The present invention functions to provide controlled application of network configuration data among network clients 120 and 130 and network access point 110 and represents a significant improvement over current technology. This application enables communication between multiple network clients and access point. Further, it allows a user to ensure that network clients are in sync with the access point and that the clients will not be cut off from the network through a lapse in memory or judgment. Additionally, the controlled application ensures that even in a network, which may interface among differing client adapter setups as well as access points having different configurations the communication links are maintained. This controlled application of network configuration data may be accomplished in a synchronous manner. The present invention shifts the responsibility of network client and access point configuration from the user to the network system itself by performing the configuration automatically.

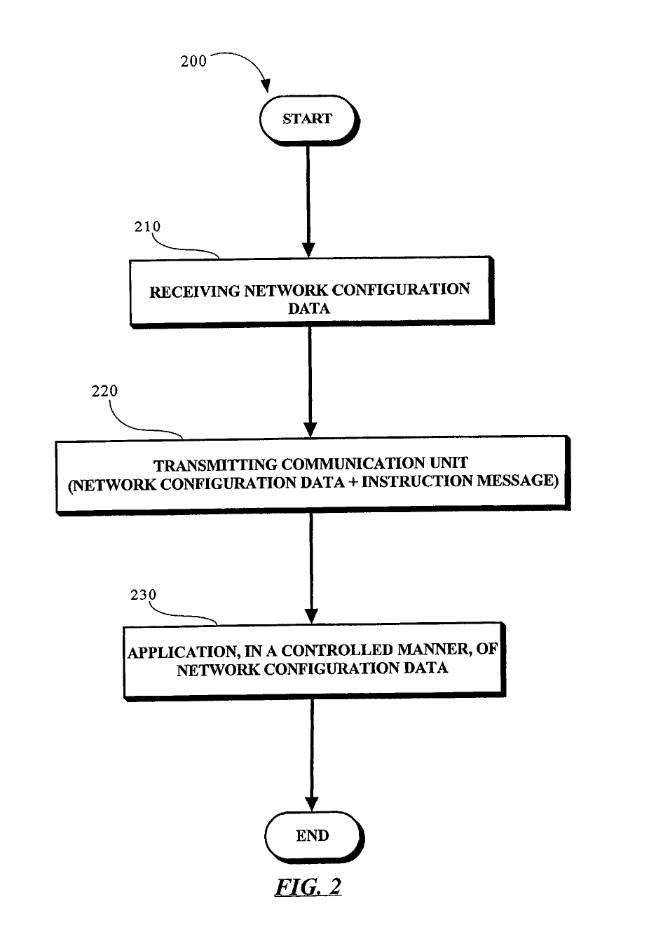

Referring now to FIG. 2 a method 200 of the controlled application of the network configuration data to network clients and the network access point is shown. In step 210 required information, such as network configuration data, is collected. This collecting is accomplished by a user interface, which allows a user to input/enter the necessary information. The user interface of step 210 can occur on any of a myriad of information handling systems from a computer to a cellular phone to a remote control to a touch-screen display monitor to a voice activated system without departing from the spirit and scope of the present invention. It is contemplated that a network client, such as network clients 120 and 130 represented in FIG. 1, can serve as the user interface information handling system and display the user interface. Entry of information may be accomplished by use of a keyboard, mouse, touch-pad, microphone and the like. The user interface communicates with the network over any of a variety of communication channels such as computer cable, fiber optic or wireless, as discussed previously. Thus, physical location of the user interface relative to the network should not be read as a limitation.

In step 220 the communication unit, comprised of the network configuration data entered through the user interface and an instruction message, is generated and transmitted. The network configuration data entered on the user interface information handling system, initiates a series of routines within the particular information handling system, which are automatic and require no user intervention. The first routine initiated involves the routing of the network configuration data upon initial entry. For example, the entered network configuration data can be routed into the memory of the information handling system or an allocated storage device (as will be described later). This is a temporary storage serving the purpose of preparing the network configuration data for its next step.

Once the network configuration data has reached its temporary storage destination a second routine is activated. This second routine accesses the instruction message to be combined with the network configuration data. This instruction message commands the network clients and the network access point to apply the network configuration data and re-boot the network clients if necessary. The instruction message can be stored in the memory of the information handling system through which the network configuration data was received or the allocated storage device, which may be peripheral in location but communicatively coupled with the network client user interface.

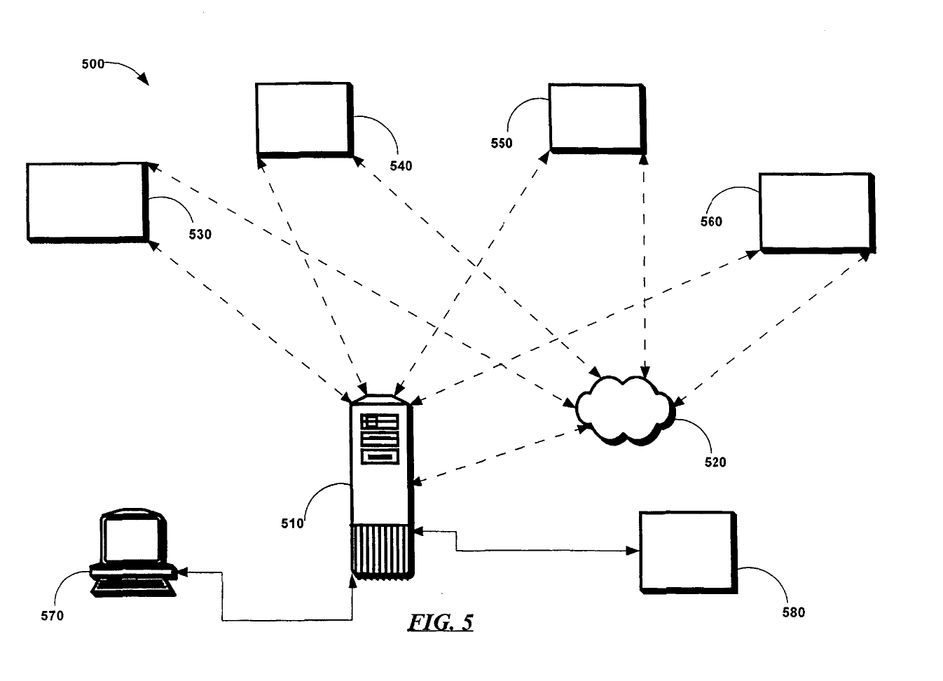

Upon accessing the instruction message a third routine accesses the network configuration data from the temporary storage where it was routed. The third routine combines the instruction message with the network configuration data to form a single communication unit. This communication unit is what is transmitted to other network clients and the network access point. If the network includes a server (as shown in FIG. 5) then the communication unit is transmitted to it as well.

Further, upon entry of the network configuration data through the user interface information handling system a fourth routine is activated. The fourth routine functions to identify the number and location of devices that are peripheral to the user interface information handling system, such as other network clients, the network access point and a server if it is included in the network, to establish communication links with them. The fourth routine sends out a locator signal, which discovers or detects the presence of any peripheral devices and then these peripheral devices send back a signal for retrieval by the user interface information handling system. The retrieved signal provides the number and location of these peripheral devices.

In a wireless network establishing these network linkages is preferable because there may be other hosts and wireless peripherals operating (e.g., transmitting and receiving) that may need to be avoided. In a network communicatively coupled with physical cables, while signal crossing with other networks is not an issue, it is nonetheless desirable to establish the number and location of any peripheral devices to ensure the entire network is properly configured.

It is contemplated that a network user, when transmitting sensitive network configuration data, may want an added level of security. This may be accomplished by utilizing an encryption program to encrypt the information of the communication unit before it is transmitted.

The transmission of the communication unit occurs after the peripheral devices have been identified using conventional techniques. A fifth routine may be established in the user interface information handling system, which enables the duplication of the communication unit to match the number of peripheral devices. This allows for synchronous control of the transmission of the communication unit from the user interface information handling system to any peripheral devices.

In step 230 the controlled application of the network configuration data by the peripheral devices occurs. The receipt of the communication unit by the peripheral devices initiates a sixth routine for the application of the network configuration data within those systems. The controlled application may occur in a synchronous manner to ensure continual network communication between the user interface information handling system and any peripheral devices. The first step involves having each peripheral device send an acknowledgment message to the user interface handling system, from which the communication unit mentioned above was sent from, that the communication unit was received. Next, the user interface information handling system verifies that this acknowledgment message is received from each peripheral device it had previously identified as included in the network. If there is a peripheral device that has not sent an acknowledgment message the user interface information handling system prompts the user with this information and asks the user to re-transmit the communication unit or abort the attempt to apply the network configuration data on the network. If the user decides to abort the process the network configuration data is deleted from the user interface information handling system and any peripheral devices. If the user decides to retransmit the communication unit, it is re-transmitted and receipt by the user interface information handling system of the acknowledgment message from the peripheral devices is awaited.

Upon verification, through receipt of acknowledgment messages that the peripheral devices have received the communication unit, the user interface information handling system transmits a timing command, which identifies to the peripheral devices that the network configuration data be applied now. This function ensures that the network configuration data is applied, in a controlled manner, onto the user interface information handling system and any peripheral device.

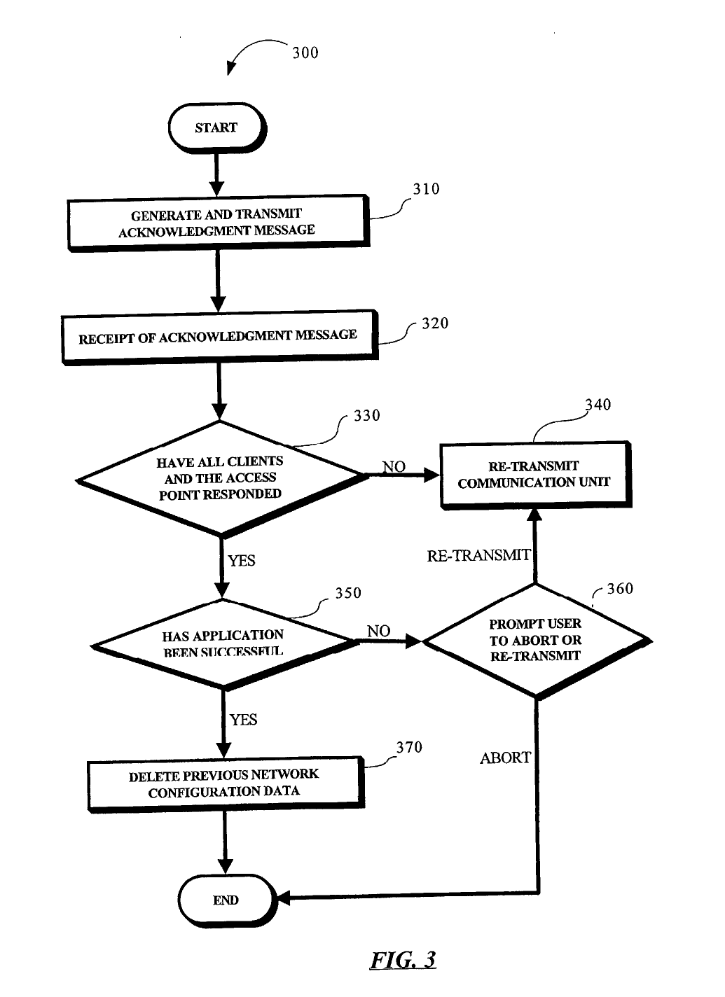

FIG. 3 depicts a method 300 for deleting previous network configuration data settings stored on network members (e.g., user interface, network clients and the network access point). Preferably, this occurs only after the receipt, transmission and application of network configuration data as shown in FIG. 2. At step 310, the network clients and the access point, through a first routine in their systems, generate and transmit an acknowledgment message. The acknowledgment message verifies whether or not the network configuration data transmitted was successfully applied on the network clients and the access point. This acknowledgment message, in step 320, is received by the user interface information handling system.

Upon receiving the acknowledgment messages step 330 represents a first function within the user interface information handling system which determines from the number of acknowledgment messages received whether or not each client and the access point have responded to the transmission of the communication unit. If this first function determines that there are still clients that have not responded or that the access point has not responded then step 340 initiates a second function, that of re-transmitting the communication unit as discussed in FIG. 2.

However, if from step 330, the user interface information handling system determines that the clients and access point have responded step 350 provides a third function to determine from the acknowledgment messages received, which ones acknowledge successful application of the network configuration data sent and which ones do not. If there are unsuccessful application acknowledgment messages, step 360 is initiated. In step 360 a second routine prompts the user with the information that application of the network configuration data on network clients and the access point has been unsuccessful and identifies them. The user interface information handling system transmits a message to the network clients and the access point informing them that application of the network configuration data over the entire system has not been successful. This message directs the clients and the access point to revert back to the previous network configuration data settings, if the network already had network configuration data settings in place. Additionally, it prompts the user to re-transmit the communication unit if desired.

If no unsuccessful acknowledgment messages are received then step 370 is a third routine that informs the user interface information handling system, network clients and the access point to delete any previous network configuration data settings. These previous network configuration data settings having been stored in the user interface information handling system, network clients and the access point.

Referring now to FIG. 4, an exemplary hardware system generally representative of the information handling system suitable for use as a network client (120 & 130 (FIG. 1), 530, 540, 550 & 560 (FIG. 5))or a user interface such as 570 (FIG. 5) is described. The hardware system 400 is controlled by a central processing system 402. The central processing system 402 includes a central processing unit such as a microprocessor or micro-controller for executing programs, performing data manipulations and controlling the tasks of the hardware system 400. Communication with the central processor 402 is implemented through a system bus 410 for transferring information among the components of the hardware system 400. The bus 410 may include a data channel for facilitating information transfer between storage and other peripheral components of the hardware system. The bus 410 further provides the set of signals required for communication with the central processing system 402 including a data bus, address bus, and control bus. The bus 410 may comprise any state of the art bus architecture according to promulgated standards, for example industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and so on. Other components of the hardware system 400 include main memory 404, and auxiliary memory 406. The hardware system 400 may further include an auxiliary processing system 408 as required. The main memory 404 provides storage of instructions and data for programs executing on the central processing system 402. The main memory 404 is typically semiconductor-based memory such as dynamic random access memory (DRAM) and/or static random access memory (SRAM). Other semi-conductor-based memory types include, for example, synchronous dynamic random access memory (SDRAM), Rambus dynamic random access memory (RDRAM), ferroelectric random access memory (FRAM), and so on. The auxiliary memory 406 provides storage of instructions and data that are loaded into the main memory 404 before execution. The auxiliary memory 406 may include semiconductor based memory such as read-only memory (ROM), programmable read-only memory (PROM), erasable programmable read-only memory (EPROM), electrically erasable read-only memory (EEPROM), or flash memory (block oriented memory similar to EEPROM). The auxiliary memory 406 may also include a variety of non-semiconductor-based memories, including but not limited to magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), etc. Other varieties of memory devices are contemplated as well. The hardware system 400 may optionally include an auxiliary processing system 408 which may be an auxiliary processor to manage input/output, an auxiliary processor to perform floating point mathematical operations, a digital signal processor (a special-purpose microprocessor having an architecture suitable for fast execution of signal processing algorithms), a back-end processor (a slave processor subordinate to the main processing system), an additional microprocessor or controller for dual or multiple processor systems, or a coprocessor. It will be recognized that such auxiliary processors may be discrete processors or may be built into the main processor.

The hardware system 400 further includes a display system 412 for connecting to a display device 414, and an input/output (I/O) system 416 for connecting to one or more I/O devices 418, 420, and up to N number of I/O devices 422. The display system 412 may comprise a video display adapter having all of the components for driving the display device, including video memory, buffer, and graphics engine as desired. Video memory may be, for example, video random access memory (VRAM), synchronous graphics random access memory (SGRAM), windows random access memory (WRAM), and the like. The display device 414 may comprise a cathode ray-tube (CRT) type display such as a monitor or television, or may comprise an alternative type of display technology such as a projection-type CRT display, a liquid-crystal display (LCD) overhead projector display, an LCD display, a light-emitting diode (LED) display, a gas or plasma display, an electroluminescent display, a vacuum fluorescent display, a cathodoluminescent (field emission) display, a plasma-addressed liquid crystal (PALC) display, a high gain emissive display (HGED), and so forth. The input/output system 416 may comprise one or more controllers or adapters for providing interface functions between the one or more I/O devices 418-422. For example, the input/output system 416 may comprise a serial port, parallel port, universal serial bus (USB) port, IEEE 1394 serial bus port, infrared port, network adapter, printer adapter, radio-frequency (RF) communications adapter, universal asynchronous receiver-transmitter (UART) port, etc., for interfacing between corresponding I/O devices such as a keyboard, mouse, trackball, touchpad, joystick, trackstick, infrared transducers, printer, modem, RF modem, bar code reader, charge-coupled device (CCD) reader, scanner, compact disc read-only memory (CD-ROM), digital versatile disc (DVD), video capture device, touch screen, stylus, electroacoustic transducer, microphone, speaker, etc. The input/output system 416 and I/O devices 418-422 may provide or receive analog or digital signals for communication between the hardware system 400 of the present invention and external devices, networks, or information sources. The input/output system 416 and I/O devices 418-422 preferably implement industry promulgated architecture standards, including Ethernet IEEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on. It should be appreciated that modification or reconfiguration of the hardware system 400 of FIG. 4 by one having ordinary skill in the art would not depart from the scope or the spirit of the present invention.

It is understood that the specific order or hierarchies of steps in the methods disclosed herein are examples of exemplary approaches. Based upon design preferences, it is understood that the specific order or hierarchy of steps in the method can be rearranged while remaining within the scope of the present invention. The attached method claims present elements of the various steps in a sample order, and are not meant to be limited to the specific order or hierarchy presented.

FIG. 5 is a representative diagram of a network 500, which is operable to employ the present invention. The present invention may include a wireless network, local area network and the like. A network server 510 may be communicatively coupled to a network access point 520 and a plurality of network clients: 530, 540, 550 and 560. The present embodiment being exemplary such that the network may contain one or more clients. Further, network clients may be information handling systems as shown in FIG. 4. The network access point 520 may be peripheral to the network server 510 or located within the network server. All network configuration data (encryption protocol settings, user profiles, network identification values and the like) are received directly in the network server by use of the dedicated central network user interface 570. The dedicated central network user interface may be an information handling system as shown in FIG. 4. The network configuration data may include wireless network configuration data. The network configuration data may be received in the network server and stored in the network server allocated storage device 580. Allocated storage device 580 is representative of the network server's storage capability. The allocated storage device may be a hard disc drive communicatively coupled to the network server and may be peripheral to or located within the network server.

It is believed that the system and method for centralizing and synchronizing network configuration data of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The system and method herein before described being merely an explanatory embodiment thereof. It is the intention of the following claims to encompass and include such changes.

What is claimed is:

1. A network system, comprising:
one or more information handling systems; and
a network access point, communicatively coupled with the one or more information handling systems utilizing a first set of network configuration data, suitable for providing communication between the one or more information handling systems and the network access point including a second set of network configuration data,
wherein, application of the second set of network configuration data on the one or more information handling systems and the network access point is in a controlled manner so as to enable communication between the one or more information handling systems and the network access point utilizing the second set of network configuration data.

2. The network system of claim 1, wherein the second set of network configuration data is received through a user interface operable on an information handling system of the one or more information handling systems.

3. The network system of claim 1, wherein a user enters the second set of network configuration data on the user interface information handling system and the second set of network configuration data is communicated to the one or more information handling systems and the network access point automatically.

4. The network system of claim 1, wherein the communication is encrypted.

5. The network system of claim 1, wherein the communication of the second set of network configuration data includes an instruction message.

6. The network system of claim 1 or 5, wherein the second set of network configuration data is communicated to the one or more information handling systems and the network access point in a synchronous manner.

7. The network system of claim 1, wherein a deletion of the first set of network configuration data on the one or more information handling systems and the network access point is accomplished by an automatic function without any user intervention.

8. The network system of claim 1, wherein the network is a local area network.

9. The network system of claim 1, wherein the network is a wireless network.

10. The network system of claim 1, wherein the one or more information handling systems are wireless information handling systems.

11. The network system of claim 1, wherein the user interface information handling system is a wireless information handling system.

12. The network system of claim 1, wherein the network access point is a wireless network access point.

13. The network system of claim 1, wherein the second set of network configuration data is wireless network configuration data.

14. A method for controlling network configuration data for a network with one or more information handling systems and a network access point, comprising:
receiving a second set of network configuration data on the network;
communicating the second set of network configuration data across the network; and
causing the second set of network configuration data to be applied to the one or more information handling systems and network access point, of the network, without manual intervention.

15. The method of claim 14, wherein the network access point, communicatively coupled with the one or more information handling systems utilizing a first set of network configuration data, is suitable for providing communication between the one or more information handling systems and the network access point utilizing the second set of network configuration data.

16. The method of claim 14, wherein the second set of network configuration data is received through a user interface operable on an information handling system of the one or more information handling systems.

17. The method of claim 14, wherein a user enters the second set of network configuration data on the user interface information handling system and the second set of network configuration data is transferred to the one or more information handling systems and the network access point automatically.

18. The method of claim 14, wherein the communication is encrypted.

19. The method of claim 14, wherein the communication of the second set of network configuration data includes an instruction message.

20. The method of claim 14 or 19, wherein the communication is in a synchronous manner.

21. The method of claim 14, wherein a deletion of the first set of network configuration data on the one or more information handling systems and the network access point is accomplished by an automatic function without any user intervention.

22. The method of claim 14, wherein the network is a local area network.

23. The method of claim 14, wherein the network is a wireless network.

24. The method of claim 14, wherein the one or more information handling systems are wireless information handling systems.

25. The method of claim 14, wherein the user interface information handling system is a wireless information handling system.

26. The method of claim 14, wherein the network access point is a wireless network access point.

27. The method of claim 14, wherein the new network configuration data is wireless network configuration data.

28. A system for controlling wireless network configuration data on a wireless
network, comprising:
one or more wireless information handling systems; and
a wireless network access point, communicatively coupled with the one or more wireless information handling systems utilizing a first set of network configuration data, suitable for providing communication between the one or more wireless information handling systems and the wireless network access point include a second set of wireless network configuration data,
wherein application of the second set of wireless network configuration data is in a controlled manner, so as to enable communication between the one or more wireless information handling systems and the wireless network access point utilizing the second set of wireless network configuration data.

29. The system of claim 28, wherein the second set of network configuration data is received through a user interface operable on an information handling system of the one or more wireless information handling systems.

30. The system of claim 28, wherein a user enters the second set of network configuration data on the user interface information handling system and the second set of network configuration data is transferred to the one or more information handling systems and the network access point automatically.

31. The system of claim 28, wherein the communication of the second set of wireless network configuration data is encrypted.

32. The system of claim 28, wherein the communication of the second set of wireless network configuration data includes an instruction message.

33. The system of claim 28 or 32, wherein the communication is in a synchronous manner.

34. The system of claim 28, wherein the wireless network is a wireless local area network.

35. The system of claim 28, wherein the user interface information handling system is a wireless user interface information handling system.

36. The system of claim 28, wherein a deletion of the first set of wireless network configuration data on the user interface information handling system, the one or more wireless information handling systems and the wireless network access point is accomplished by an automatic function without any user intervention.
